(19) United States
(12) Patent Application Publication
(10) Pub. No.: US 2025/0369339 A1
(43) Pub. Date: Dec. 4, 2025

(54) PREDICTION OF SCREEN-OUT EVENT IN A WELLBORE FROM RESISTANCE MEASURED BASED ON PRESSURE PULSE

(71) Applicant: Halliburton Energy Services, Inc., Houston, TX (US)

(72) Inventors: Dinesh Ananda Shetty, Houston, TX (US); Ning Tu, Singapore (SG); Sergei Parsegov, Houston, TX (US)

(21) Appl. No.: 19/013,800

(22) Filed: Jan. 8, 2025

Related U.S. Application Data
(60) Provisional application No. 63/653,605, filed on May 30, 2024.
(60) Provisional application No. 63/654,764, filed on May 31, 2024.

(51) Int. Cl. E21B 47/00; E21B 37/00; G01V 99/00

(52) U.S. Cl. CPC E21B 47/006; G01V 99/00; E21B 37/00; E21B 2200/20

(57) ABSTRACT

Embodiment of a method, apparatus, and non-transitory computer readable medium for predicting a screen out event are disclosed herein. In one embodiment, a method comprises obtaining water hammer data for a wellbore; determining an inferred resistance for the wellbore from the water hammer data; comparing the inferred resistance for the wellbore with a measured resistance, wherein the measured resistance comprises at least one of an eroded resistance or a growth rate of the resistance for the wellbore; and predicting a screen-out event occurring in the wellbore based on at least the comparison of the inferred resistance with the measured resistance.

### CLAIM OF PRIORITY

This application claims priority to U.S. provisional application No. 63/653,605, filed on May 30, 2024, entitled “PREDICTION OF SCREEN-OUT EVENT IN A WELLBORE FROM RESISTANCE MEASURED BASED ON PRESSURE PULSE,” the entire content of which is incorporated herein by reference.

### FIELD

Some implementations relate generally to the field of downhole fluid flow and more particularly to the field of predicting screen-out occurring in a subsurface formation.

### BACKGROUND

In the oil and gas industry, hydraulic fracturing is a common method used to create higher conductive channels to the wellbore and thus increase productivity of the reservoirs. In hydrocarbon recovery operations, one or more fluids may be introduced into the wellbore at high pressure to initiate fractures inside the reservoir and transport proppants (sand particles) into those fractures. Accumulation of proppant particles inside the fractures may cause blockages and lead to pressure max out on pumping units. The disclosure relates to predicting such undesirable condition and adjusting wellbore operations based on the prediction.

### BRIEF DESCRIPTION OF THE DRAWINGS

Implementation of the disclosure may be better understood by referencing the accompanying drawings.

FIG. 1 is a diagrammatic illustration of an example well system, according to some implementations.

FIG. 2 is an example system for predicting screen-out events in a wellbore, according to some implementations.

FIG. 3 is a flowchart of example operations for a screen-out event, according to some implementations.

FIG. 4 is an example neural network, according to some implementations.

FIG. 5 is a flowchart depicting example operations to configure a machine learning model, according to some implementations.

FIG. 6 is a block diagram depicting an example computer, according to some implementations.

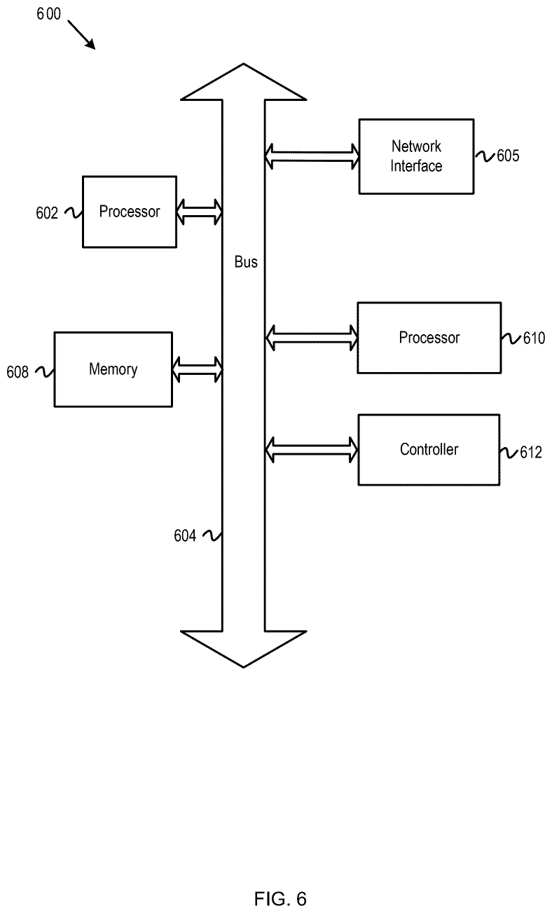

### DESCRIPTION

The description that follows may include example systems, methods, techniques, and program flows that embody implementations of the disclosure. However, this disclosure may be practiced without these specific details. For clarity, some well-known instruction instances, protocols, structures, and techniques may not be shown in detail.

### Overview

In hydraulic fracturing operations, screen-out is an undesirable situation when some restricted flow area, for example, a fracture or a perforation hole, is blocked by certain solids. For example, proppants, such as sand may build up in the perforation hole and cause an unexpected restriction in fluid flow. Aside from having a negative impact on operation efficiency, screen-out can cause abrupt spike in the wellbore pressure and can lead to hazardous situations on surface, including damage to production components such. When a screen-out event occurs, pumping will need to be ramped down and a cleaning operation may be required to recover the well, such as a coil tubing run in hole for cleaning.

Example implementations relate to methods and implementations to predict screen-out events and adjust wellbore operations to prevent the screen-out event. Each method begins by determining current (or inferred) resistance in the wellbore and comparing the inferred resistance with a measured resistance, the measured resistance as designed (or after erosion of wellbore elements with proppant particles). A rule-based discrimination comparison approach may be used, data may also be used to train a machine learning model to compare and predict screen-out events, or the rule-based comparison may be combined with the trained machine learning model as a complement to each other.

In one example, a method for predicting a screen-out event in a wellbore may include at least obtaining water hammer pressure data for a wellbore; determining an inferred resistance for the wellbore from the water hammer data; comparing the inferred resistance for the wellbore with a measured resistance. In one embodiment, the measured resistance is an eroded resistance for the wellbore after erosion of wellbore elements; and predicting a screen-out event occurring in the wellbore. The screen-out event may be predicted using either a rule-based discrimination, a machine learning model, or a combination of both. In some examples, an operation in a wellbore may be modified or directed based on the predicted screen-out event. In some examples, predicting the screen-out event may be based on at least the comparing of the inferred resistance with a measured resistance, wherein the measured resistance in some embodiments is the theoretical resistance based on perforation design with erosion effects taking into account, which may be either explicit or implicit depending on whether the rule-based discrimination or the machine learning model approach is used.

In some implementations, the machine learning model may include computer code and/or a neural network, and be implemented on a non-transitory computer readable medium, circuitry, and/or any other logic components configured to perform the operations described herein.

### Example Systems

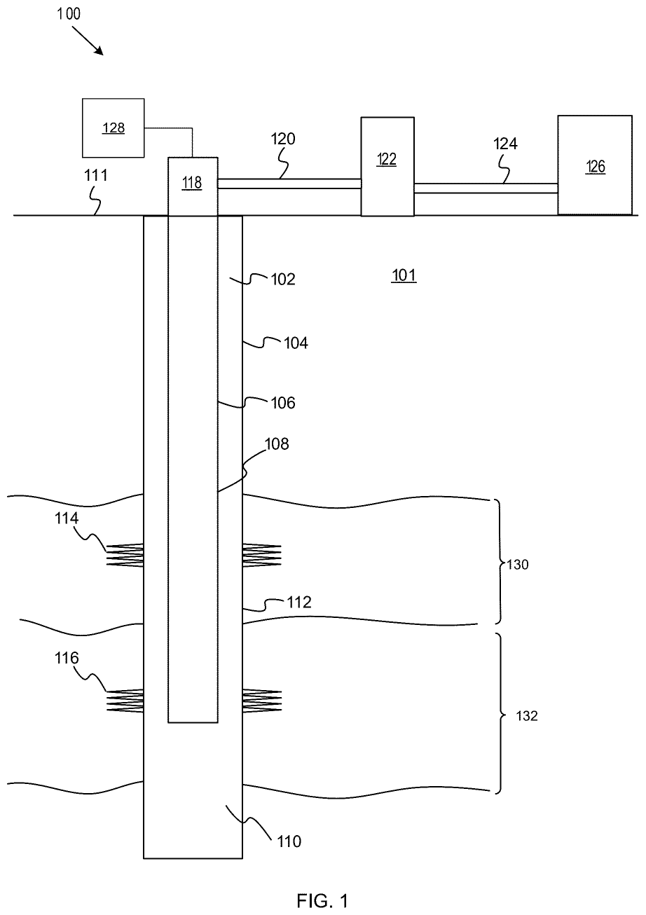

FIG. 1 is a diagrammatic illustration of an example well system, according to some implementations. In particular, a well system 100 of FIG. 1 includes a wellbore 102 in a subsurface formation 101. Although the wellbore is illustrated as a vertical well, the well can also be horizonal or oblique in the subsurface formation 101. The wellbore 102 includes casing 104 and number of perforations 114, 114 being made in the casing 104. Each set of perforations 114, 114 is located in a respective reservoir 130, 132 to connect the well with the subsurface formation 101 and allow reservoir fluids (i.e., oil, water, and gas) from the respective reservoirs 130, 132 to flow into the wellbore 102 and into the casing 104 (tubular string). Instead of perforations, there might be sliding sleeves having perforations/openings in an outer diameter thereof placed within the wellbore 102.

A flowline 120 coupled to the wellhead 118 of wellbore 102 may allow the fluid produced from the wellbore to flow up the casing 104 (tubular string), and also enable a pump 122 to pump fluid into the wellbore 102. The pump 122 may pump a fluid or slurry into the wellbore 102 to fracture the rock, and a proppant in the slurry, such as sand, may fill and prop open the perforations 114, 114 to enable production fluid to enter the flowline 120. The fluid produced from wellbore 102 may then flow to a tank battery, via flowline 120, that may include components such as storage tank 124, to store the different phases of fluid in respective tanks.

Some implementation of methods according to this disclosure may include a hydraulic fracturing and data acquisition instrument system, including sensors (which may include pressure transducers and hydrophone), a pressure source or pulsed pressure source 128 to generate waves in the wellbore 102, and a signal processing apparatus, which may be coupled with or comprise a processor. In some examples pressure or acoustic data may be obtained from fiber-optic measurements. In some examples, a propagating water hammer may be generated either by a change in rate of pumping, or a tube wave that may be generated by the pressure source 128. Resistance and pressure within the wellbore 102 may then be determined by modeling and inversion of water hammer events and pulses within the wellbore.

### Example System

Examples of a system configured to predict screen-put events are now described.

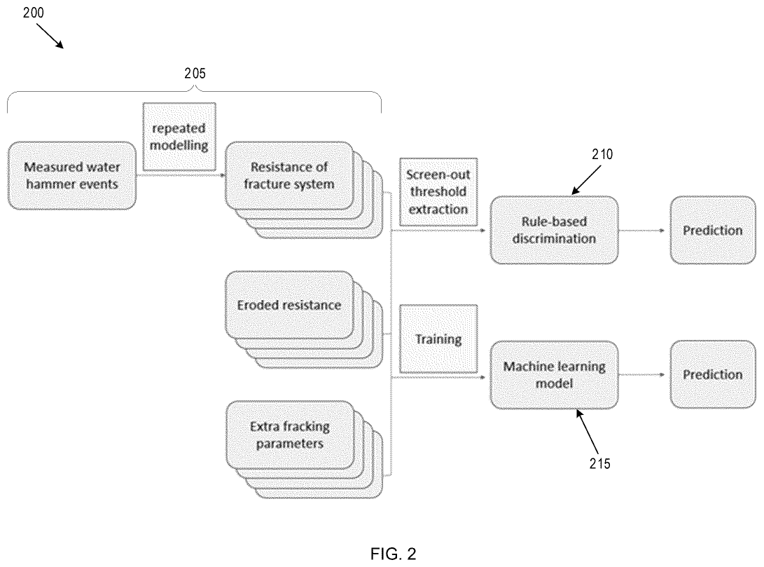

FIG. 2 is an illustration of an example system, according to some implementations. In particular, FIG. 2 is a diagram of a system 200 for predicting a screen-out event in a wellbore. Inputs 205 needed to determine a screen-out event include measured water hammer events (pressure pulses), determined current/inferred resistance of the fracture system based on the measured water hammer events, the eroded resistance of the wellbore based on design parameters, and extra hydraulic fracturing parameters (commonly referred to as “fracking” parameters). The extra hydraulic fracturing parameters may include various design parameters such as wellbore geometry and dimensions, fluid characteristics such as temperature, viscosity, and velocity, speed of sound in the wellbore, and various other design parameters well known in the art.

Predictions of a screen-out event may be made using at least a first approach and a second approach. The first approach may include rule-based discrimination 210, wherein a screen-out event is predicted based on a ratio between the inferred resistance and the eroded resistance with extraction of a screen-out threshold. The second approach may include training a machine learning model 215 based on the inputs 205, which may be trained based on the inputs to differentiate between screen-out events and non screen-out events and output a probability of a screen-out event. A third approach combines the rule-based discrimination 210 and the machine learning model 215 by using the outcome of both to complement each other.

### Example Operations

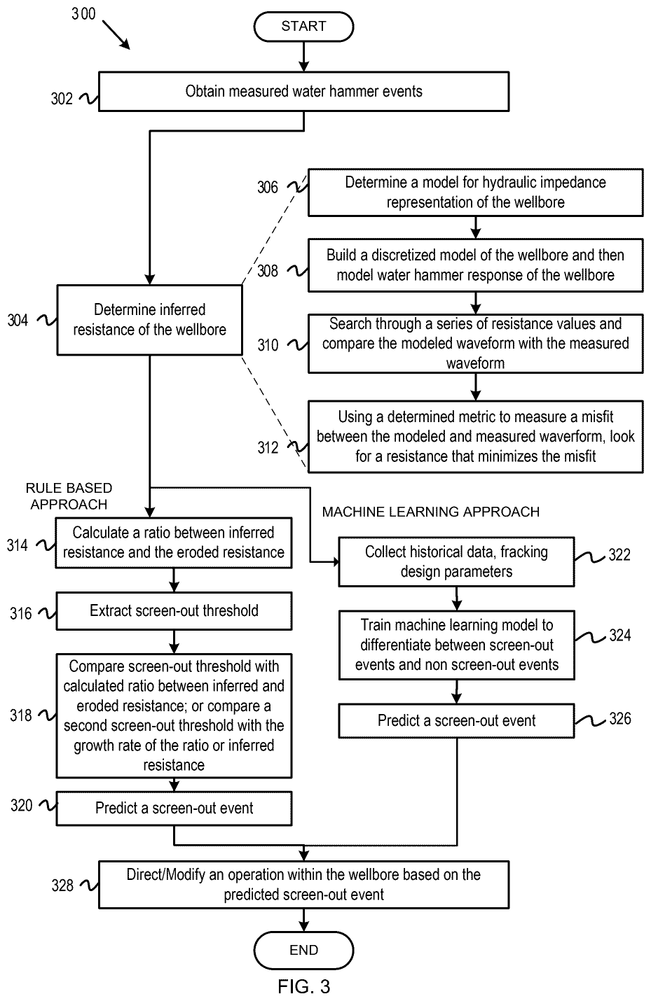

FIG. 3 is a flowchart of example operations for predicting a screen-out event. Operations begin at a block 302, obtaining measured water hammer or pressure pulse events from the fracture system/wellbore. At a step 304 an inferred resistance of the wellbore is determined by modeling and inversion of water hammer events. The modeling and inversion of the water hammer events may include features described in blocks 306-314. In a block 306 a model is determined for hydraulic impedance representation of the wellbore. In this example, a resistance model may be used to describe the hydraulic impedance of the fracture system/wellbore. In a block 308 a numerical modeling approach may be used to build a discretized model of the wellbore and model the water hammer response of the wellbore. The modeling of the water hammer response may use a given resistance as the boundary condition at the well bottom and a fluid flow rate or pressure change as the boundary condition at the wellhead. At a block 310, the resistance model may search through a series of resistance values, and compare the modeled waveform with the measured waveform. At a block 312, a determined metric may be used to measure a misfit between the modeled and measured waveform to get the difference between the two waveforms, and then look for the resistance that minimized the misfit. The determined metric may be one of the L2 norm, the L1 norm (non-smooth, but more sensitive to fine differences), or the Huber norm (a smooth version of the L1 norm that compromises between the L2 and L1 norms). In most implementations, the L2 norm may be used.

A rule based discrimination, a machine learning model, or a complement of both may then be used to predict a screen-out event.

If a rule-based discrimination is used, operations continue at a block 314. At block 314, the ratio between inferred resistance and eroded resistance is calculated. The eroded resistance is the designed resistance for the wellbore calculated using hydraulic fracturing design parameters.

At a block 316 a screen-out threshold is extracted from at least the measured water hammer events and the modeled water hammer response and historical wellbore events and data.

At a block 318, the screen-out threshold is compared with the calculated ratio between the inferred and eroded resistance or alternatively, compare a second screen-out threshold with the growth rate of the ratio or inferred resistance. When this ratio or inferred resistance continues to increase, the probability of a screen-out increases as well. When the ratio is beyond a threshold, or if this ratio or inferred resistance increases at a rate higher than a second threshold, the rule based approach will result in a prediction/warning that a screen-out event is likely to happen. Both thresholds are obtained from historical screen-out events. The screen-out event is predicted at a block 320.

For a machine learning based screen-out prediction, operations continue at a block 322. Historical data is collected including screen-out events and non-screen-out events and then combined with the inferred and eroded resistances, along with other hydraulic fracturing and design parameters. The data collected at block 322 is then used to train the machine learning model at a block 324. The machine learning model is trained to differentiate between screen-out and non screen-out events the two types of events and output a probably of a screen-out event. A screen-out event is predicted at a block 326. The machine learning model can adapt to difference in architectures. For example, when a prediction only relies on current hydraulic fracturing stage's water hammer response, a variety of models can be used, for example, random-forest based models, supporting-vector machines, artificial neural networks etc. When a prediction relies on the water hammer responses of both current and previous stages, a model that can interpret serial data can be used, for example, recurrent neural network, long short-term memory network, etc.

When a screen-out event is predicted, proppant (sand) concentration, pumping rate or amount of friction reducer chemical may be directed, modified, or performed in the wellbore in response to the predicted screen-out event at a block 328.

Some alternative examples and implementations may be used in the operations described above. For example, instead of using a resistance model to describe the hydraulic impedance of the fracture system, an alternate model may be a resistance (R)+capacitance (C)+inductance (L) model, or a subset, but that usually includes resistance (R), such as R+C, R+L, or R+C+L. A theoretical fluid flow model, such as an orifice model may be used to model the flow through a local restriction with a constant or variable opening area. Other physical models that can describe the fracture system with a certain degree of approximation may also be used.

At block 308, rather than using a numerical modeling approach to model the water hammer response in the wellbore, an alternate approach may include an analytical modeling approach, in either time domain or frequency domain.

At block 310, instead of searching through a series of resistance values to compare the modeled waveform with the measured waveform, a gradient-based or non-gradient-based optimization approach may be used to search for the optimal model parameter(s) that describe the hydraulic impedance of the fracture system.

At block 312, a different metric may be used rather than the L2 to measure the measure the misfit. The alternate metric may be based on a correlation between the two types of waveforms, a weighted correlation between the two types of waveforms, may be the L1 norm or the Huber norm, or any other metric that may be used as a measurement of distance between the two types of waveforms.

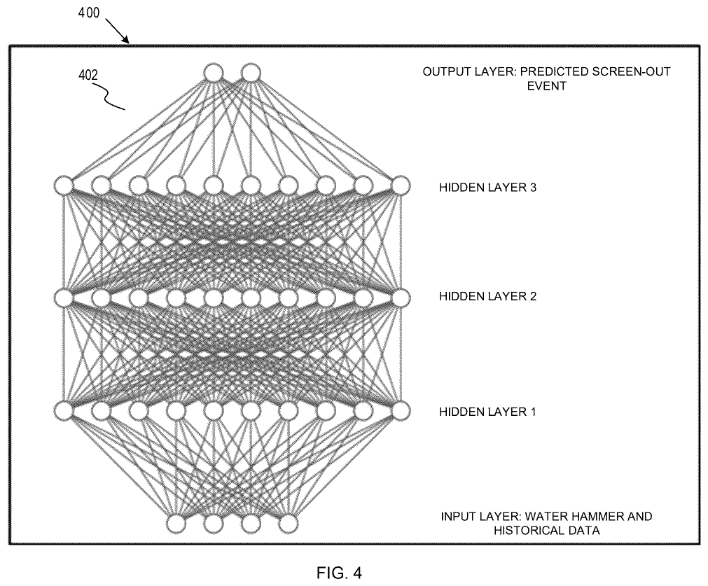

FIG. 4 is diagram illustrating an example neural network 402 that may be used in an example machine learning model 400 to execute a machine learning model. The machine learning model 400 includes the neural network 402. The neural network 402 may include an input layer that intakes information (sometimes referred to as features) about water hammer data, inferred and eroded resistance of the wellbore, threshold data, hydraulic fracturing parameters, well geometry, and/or any other suitable information about the wellbore. Although the input layer is shown having four neurons, there may be any suitable number of neurons (hence, any suitable number of features). The neural network 402 also may include an output layer that predicts a screen-out event based on the information that was fed into the input layer.

The neural network 402 may perform training based on wellbore design inputs, pressure pulse signatures, rate and proppant concentration and/or any other suitable data about the well (internal diameter of casing, perforations design, location of stage isolation-plug or sleeve, etc.). The process for training the machine learning model 400 may find optimal neural network parameters (such as weights, biases, etc.) that match the historical screen-out events.

Operations for training the neural network 402 may include creating or obtaining a training data set and inputting the training data set to the neural network. The training data set may include water hammer events, resistance data, hydraulic fracturing parameters, and historical events. During training, the neural network 402 may receive historical data of screen-out events and non screen-out events and make a prediction about screen-out events based on the training data including the historical data.

After the training is complete, the machine learning model 400 may be used to predict screen-out events that may occur in the wellbore, or a designed wellbore.

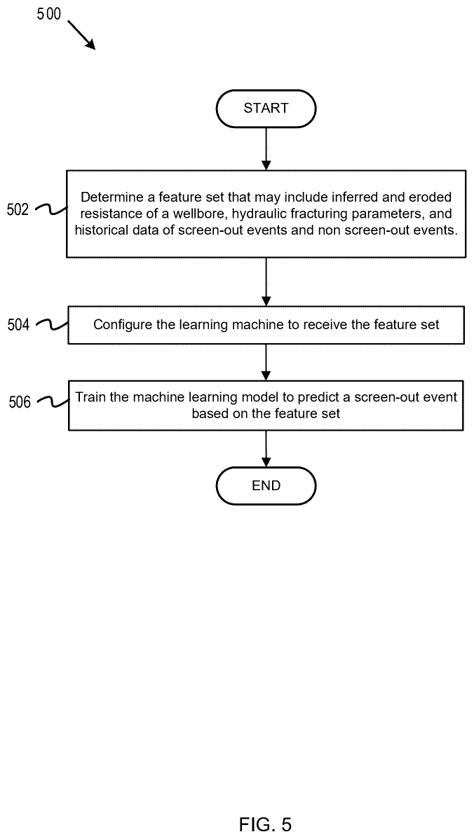

FIG. 5 is a flowchart depicting example operations to configure a machine learning model, according to some implementations. Operations begin at a block 502. At block 502, a feature set may be determined, in some examples by a processor, for a machine learning model that may include at least inferred resistance of a wellbore, eroded resistance of the wellbore, hydraulic fracturing parameters, and historical data of screen-out events and non screen-out events. At a block 504, the machine learning model is configured to receive the feature set. At a block 506, the machine learning model is trained to predict a screen-out event based on at least the feature set. The machine learning model may include into a neural network, such as neural network 402, which may be a convolutional neural network (CNN). The machine learning model may be updated (i.e., trained) as new data and calculations are obtained.

### Example Computer

In some implementations, the machine learning model 400 may be integrated into a computer system. FIG. 7 is a block diagram illustrating a computer system 700 that may be utilized with some implementations. Computer system 700 may include one or more processors 702 connected to a system bus 704. The system bus 704 may be connected to memory 708 and a network interface 705. The memory 708 may include any suitable memory random access memory (RAM), non-volatile memory (e.g., magnetic memory device), and/or any device for storing information and instructions executable by the processor(s) 702. The network interface 705 may provide connectivity to any suitable network, such as a wired network, wireless network, satellite network, etc.

The computer system 700 may include additional peripheral devices. For example, the computer system 700 may include multiple external multiple processors. In some implementations, any of the components can be integrated or subdivided.

The computer system 700 also may include a processor 710. The processor 710 may implement the methods and operations described herein, including calculating the inferred resistance, the ratio between the inferred and eroded resistance and applying the rule base discrimination. The processor 710 may include a machine learning model 400 (as described herein). The machine learning model 400 may include a neural network 402 or other logic for performing the machine learning model operations described herein. In some implementations, the computer system 700 may be included in the well system (such as the well system described with reference to FIG. 1 and may cooperate with other components and/or systems to perform the functionality described herein.

The computer system 700 also may include a controller 712 configured to perform operations in response to the predicted screen-out event.

Any component of the computer system 700 can be implemented as hardware, firmware, and/or machine-readable media including computer-executable instructions for performing the operations described herein. For example, some implementations include one or more non-transitory machine-readable media including computer-executable instructions including program code configured to perform functionality described herein. Machine-readable media includes any mechanism that provides (e.g., stores and/or transmits) information in a form readable by a machine (e.g., a computer system). For example, tangible machine-readable media includes read only memory (ROM), random access memory (RAM), magnetic disk storage media, optical storage media, flash memory machines, etc. Machine-readable media also includes any media suitable for transmitting software over a network.

While the aspects of the disclosure are described with reference to various implementations and exploitations, it will be understood that these aspects are illustrative and that the scope of the claims is not limited to them. In general, predicting a screen-out event in a wellbore as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example process in the form of a flow diagram. However, some operations may be omitted and/or other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described should not be understood as requiring such separation in all implementations, and the described program components and systems may generally be integrated together in a single software product or packaged into multiple software products. Additionally, other implementations are within the scope of the following claims. In some cases, the actions recited in the claims may be performed in a different order and still achieve desirable results.

### Example Implementations

Aspects disclosed herein include:

Aspect A: A method for predicting a screen-out event in a wellbore comprising obtaining water hammer data for a wellbore; determining an inferred resistance for the wellbore from the water hammer data; comparing the inferred resistance for the wellbore with an eroded resistance, or a growth rate of the inferred resistance for the wellbore; and predicting a screen-out event occurring in the wellbore, based on at least the comparing of the inferred resistance with the eroded resistance, or the growth rate of the inferred resistance.

Aspect B: A system comprising: a device configured to collect water hammer data from a wellbore; a processor; and a computer-readable medium having instructions stored thereon that are executable by the processor, the instructions including, instructions to calculate an inferred resistance for the wellbore based on the water hammer data, and instructions to compare the inferred resistance for the wellbore with a measured resistance, wherein the measured resistance comprises at least one of an eroded resistance or a growth rate of the inferred resistance for the wellbore; and instructions to predict a screen-out event occurring in the wellbore, based on at least the comparison of the inferred resistance with the measured resistance.

Aspect C: A non-transitory, computer-readable medium having instructions stored thereon that are executable by a processor, the instructions comprising: instructions to collect water hammer data from a wellbore; instructions to calculate an inferred resistance for the wellbore based on the water hammer data, instructions to compare the inferred resistance for the wellbore with a measured resistance, wherein the measured resistance comprises at least one of an eroded resistance or a growth rate of the inferred resistance for the wellbore; and instructions to predict a screen-out event occurring in the wellbore, based on at least the comparison of the inferred resistance with the measured resistance.

Aspects A, B, and C may have one or more of the following additional features in combination:

Feature 1: wherein predicting the screen-out event is performed using a rule-based discrimination, including comparing a ratio of the inferred resistance to the eroded resistance against a first screen-out threshold.

Feature 2: wherein the rule-based discrimination further includes comparing the growth rate of the inferred resistance to a second screen-out threshold.

Feature 3: wherein the first and second screen-out thresholds are determined according to historical data.

Feature 4: wherein predicting the screen-out event includes training a machine learning model to predict screen-out events.

Feature 5: further comprising: determining, for the machine learning model, a feature set for training the model, the feature set including at least the inferred resistance and the eroded resistance, hydraulic fracturing parameter data, and historical data of screen-out and non screen-out events; and configuring the machine learning model to receive the feature set as input.

Feature 6: wherein predicting the screen-out event is performed using a rule-based discrimination and a trained machine learning model, and wherein the predicted screen-out event by the rule-based discrimination and the predicted screen-out event of the trained machine learning model are used to complement the predicted screen-out events of each other.

Feature 7: further comprising: performing an operation in the wellbore based on the predicted screen-out event.

Feature 8: wherein the instructions to compare the inferred resistance for the wellbore with the measured resistance includes comparing a second screen-out threshold with a growth rate of the inferred resistance; and wherein the instructions to predict a screen-out event in the wellbore is further based on the comparison of the second screen-out threshold with the growth rate of the inferred resistance

Feature 9: the instructions to predict the screen-out event include instructions using a rule-based discrimination, including one of comparing a ratio of the inferred resistance to the eroded resistance against a first screen-out threshold and comparing the growth rate of the inferred resistance to a second screen-out threshold.

Feature 10: wherein the first and second screen-out thresholds are determined according to historical data.

Feature 11: wherein the instructions to predict the screen-out event include instructions to train a machine learning model to predict a screen-out event.

Feature 12: wherein the instructions to train the machine learning model include instructions to determine a feature set for training the machine learning model, the feature set including at least the inferred resistance and the eroded resistance, hydraulic fracturing parameter data, and historical data of screen-out and non screen-out events; and instructions to configure the machine learning model to receive the feature set as input.

Feature 13: wherein the instructions to predict the screen-out event is performed using a rule-based discrimination and the trained machine learning model, and wherein the predicted screen-out event by the rule-based discrimination and the predicted screen-out event of the trained machine learning model are used to complement the predicted screen-out events of each other.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

As used herein, the term “or” is inclusive unless otherwise explicitly noted. Thus, the phrase “at least one of A, B, or C” is satisfied by any element from the set {A, B, C} or any combination thereof, including multiples of any element.

1. A method comprising:
obtaining water hammer data for a wellbore;
determining an inferred resistance for the wellbore from the water hammer data;
comparing the inferred resistance for the wellbore with a measured resistance, wherein the measured resistance comprises at least one of an eroded resistance or a growth rate of the inferred resistance for the wellbore; and
predicting a screen-out event occurring in the wellbore based on at least the comparison of the inferred resistance with the measured resistance.

2. The method of claim 1, wherein predicting the screen-out event is performed using a rule-based discrimination, including comparing a ratio of the inferred resistance to the eroded resistance against a first screen-out threshold.

3. The method according to claim 2, wherein the rule-based discrimination further includes comparing the growth rate of the inferred resistance to a second screen-out threshold.

4. The method of claim 3, wherein the first and second screen-out thresholds are determined according to historical data.

5. The method of claim 1, wherein predicting the screen-out event includes training a machine learning model to predict screen-out events.

6. The method of claim 5, further comprising:
determining, for the machine learning model, a feature set for training the model, the feature set including at least the inferred resistance and the eroded resistance, hydraulic fracturing parameter data, and historical data of screen-out and non screen-out events; and
configuring the machine learning model to receive the feature set as input.

7. The method of claim 1, wherein predicting the screen-out event is performed using a rule-based discrimination and a trained machine learning model, and wherein the predicted screen-out event by the rule-based discrimination and the predicted screen-out event of the trained machine learning model are used to complement the predicted screen-out events of each other.

8. The method of claim 1, further comprising:
performing an operation in the wellbore based on the predicted screen-out event.

9. A system comprising:
a device configured to collect water hammer data from a wellbore;
a processor; and
a computer-readable medium having instructions stored thereon that are executable by the processor, the instructions including,
instructions to calculate an inferred resistance for the wellbore based on the water hammer data, and
instructions to compare the inferred resistance for the wellbore with a measured resistance, wherein the measured resistance comprises at least one of an eroded resistance or a growth rate of the inferred resistance for the wellbore; and
instructions to predict a screen-out event occurring in the wellbore, based on at least the comparison of the inferred resistance with the measured resistance.

10. The system according to claim 9,
wherein the instructions to compare the inferred resistance for the wellbore with the measured resistance includes comparing a second screen-out threshold with a growth rate of the inferred resistance; and
wherein the instructions to predict a screen-out event in the wellbore is further based on the comparison of the second screen-out threshold with the growth rate of the inferred resistance.

11. The system of claim 9, the instructions to predict the screen-out event include instructions using a rule-based discrimination, including one of comparing a ratio of the inferred resistance to the eroded resistance against a first screen-out threshold and comparing the growth rate of the inferred resistance to a second screen-out threshold.

12. The system of claim 11, wherein the first and second screen-out thresholds are determined according to historical data.

13. The system of claim 9, wherein the instructions to predict the screen-out event include instructions to train a machine learning model to predict a screen-out event.

14. The system of claim 13, wherein the instructions to train the machine learning model include instructions to determine a feature set for training the machine learning model, the feature set including at least the inferred resistance and the eroded resistance, hydraulic fracturing parameter data, and historical data of screen-out and non screen-out events; and
instructions to configure the machine learning model to receive the feature set as input.

15. The system of claim 13, wherein the instructions to predict the screen-out event is performed using a rule-based discrimination and the trained machine learning model, and wherein the predicted screen-out event by the rule-based discrimination and the predicted screen-out event of the trained machine learning model are used to complement the predicted screen-out events of each other.

16. A non-transitory, computer-readable medium having instructions stored thereon that are executable by a processor, the instructions comprising:
instructions to collect water hammer data from a wellbore;
instructions to calculate an inferred resistance for the wellbore based on the water hammer data,
instructions to compare the inferred resistance for the wellbore with a measured resistance, wherein the measured resistance comprises at least one of an eroded resistance or a growth rate of the inferred resistance for the wellbore; and
instructions to predict a screen-out event occurring in the wellbore, based on at least the comparison of the inferred resistance with the measured resistance.

17. The non-transitory, computer-readable medium according to claim 16, wherein the instructions to predict the screen-out event is performed using a rule-based discrimination, including one of comparing a ratio of the inferred resistance to the eroded resistance against a first screen-out threshold and comparing the growth rate of the inferred resistance to a second screen-out threshold.

18. The non-transitory, computer-readable medium according to claim 17, wherein either of the first or second screen-out thresholds is determined according to historical data.

19. The non-transitory, computer-readable medium according to claim 16, wherein the instructions to predict the screen-out event include instructions to train a machine learning model to predict a screen-out event,
wherein the instructions to train the machine learning model, include determining a feature set for training the machine learning model, the feature set including at least inferred resistance and the eroded resistance, hydraulic fracturing parameter data, and historical data of screen-out and non screen-out events, and
instructions to configure the machine learning model to receive the feature set as input.

20. The non-transitory, computer-readable medium according to claim 16, wherein the instructions to predict the screen-out event include instructions to train a machine learning model to predict a screen-out event, wherein the instructions to predict the screen-out event is performed using a rule-based discrimination and the trained machine learning model, and wherein the predicted screen-out event by the rule-based discrimination and the predicted screen-out event of the trained machine learning model are used to complement the predicted screen-out events of each other.
